(19) United States
(12) Patent Application Publication
(10) Pub. No.: US 2007/0095387 A1
(43) Pub. Date: May 3, 2007

(54) Solar cell module

(76) Inventors: Shuichi Fujii, Higashiohmi-shi (JP); Toshihiko Kaneko, Higashiohmi-shi (JP); Takashi Tsuge, Ise-shi (JP); Katsuhiko Shirasawa, Higashiohmi-shi (JP)

Correspondence Address: HOGAN & HARTSON L.L.P., 1999 AVENUE OF THE STARS, SUITE 1400, LOS ANGELES, CA, 90067, US

(21) Appl. No.: 10/580,982

(22) PCT Filed: Nov. 26, 2004
(86) PCT No.: PCT/JP04/17985

§ 371 Date: May 25, 2006

(30) Foreign Application Priority Data
Nov. 27, 2003 (JP) 2003-398197
Dec. 25, 2003 (JP) 2003-431603
Mar. 29, 2004 (JP) 2004-096815

(51) Int. Cl. H02N 6/00

(52) U.S. Cl. 136/251

(57) ABSTRACT

The largest stress is created in the vicinity of the boundary between an edge of a bus bar electrode in a solar cell and a surface of a semiconductor substrate, and stress are easily concentrated. Accordingly, defects such as micro cracks occur in the semiconductor substrate, which develop into a large craze with the defects as its starting point. In connecting bus bar electrodes 4a and 5a in the solar cell by an inner lead 8, therefore, a solder 6 is not brought into contact with edges along the longitudinal direction if the bus bar electrodes 4a and 5a and portions F from the edges to a predetermined distance a inward therefrom, and is brought into direct contact with a filler 10.

### TECHNICAL FIELD

The present invention relates to a solar cell module, and more particularly to a solar cell module in which a plurality of solar cells each having an electrode formed therein are connected to a semiconductor substrate by an inner lead.

### BACKGROUND ART

A solar cell is produced using a single crystalline silicon substrate or a polycrystalline silicon substrate. Therefore, the solar cell is weak in physical shock, and must be protected from rain or the like when the solar cell is mounted outdoors. Since one solar cell hardly generates electrical output, a plurality of solar cells must be connected in series so that practical electrical output can be extracted.

Therefore, a method of connecting a plurality of solar cells, interposing the connected solar cells between translucent panel and a back surface protect member, and sealing a filler mainly composed of an ethylene vinyl acetate copolymer (EVA) or the like among the solar cells, to produce a solar cell module is generally carried out. The solar cells, which are linearly connected in series, are referred to as a solar cell string.

In such a solar cell module, solar cells are connected to one another by a long narrow conductor called an inner lead, and long narrow conductors called outer leads appear in the solar cells at both its ends. Outer leads in a plurality of strings are connected to one another in parallel by a coupling wiring, to produce a solar cell panel.

Such an inner lead, an outer lead, and a coupling wiring are generally formed of a solder-coated copper foil having a thickness of approximately 0.1 to 1.0 mm and having a width of 2 to 8 mm, the whole surface of the copper foil coated with a solder. They are cut to a predetermined length and used.

The solder is generally a eutectic solder having a composition of approximately 63% by weight of tin and approximately 37% by weight of lead.

When the inner lead and the solar cell are connected to each other using the solder, as described above, a surface of a current collecting bus bar electrode formed on a surface of the solar cell is previously provided with coating with the solder, and the coating, together with coating with the solder in the inner lead, is thermally welded.

Alternatively, only the inner lead is provided with coating with the solder, and the solder in the inner lead is directly thermally welded to the bus bar electrode without solder coating thereon using a flux.

In the conventional solar cell, the substrate in the solar cell is sometimes cracked along the bus bar electrode.

FIG. 9 is a cross-sectional view of a connector between a bus bar electrode 5a on a silicon substrate 1 in a solar cell and an inner lead 8. Stresses applied to a cross section of a silicon substrate 1 are drawn by arrows. The cross-sectional view is drawn by exaggerating the size of a principal part in order to make a configuration easy to understand, the dimensional ratio of which differs from the actual dimensional ratio.

As shown in FIG. 9, the bus bar electrode 5a which is an output extraction terminal is coated with a solder 6 to its edge along the longitudinal direction of the bus bar electrode. At this time, it is found that the largest tensile stress is created in the vicinity of the boundary between the edge of the bus bar electrode 5a and a surface of the silicon substrate 1 (indicated by “Q” in FIG. 9), so that stresses are easily concentrated.

The stresses cause some problems. For example, defects such as micro cracks occur in the silicon substrate 1 near the bus bar electrode 5a, which develop into a large craze in the subsequent manufacturing process. Further, an output cannot be sufficiently extracted or is lowered.

Particularly, the solar cell module is generally installed outdoors, so that contraction and expansion due to a daily temperature cycle are repeated. Stresses at this time are applied to the vicinity of the boundary between the edge of the bus bar electrode 5a and the surface of the silicon substrate 1. Therefore, micro cracks are generated on the solar cell, resulting in decreased long-term reliability.

In producing a solar cell module, the inner lead 8 which is previously coated with a solder is welded to the bus bar electrode 5a, to join the bus bar electrode 5a and the inner lead 8. At this time, when the inner lead 8 is shifted so that the solder is welded to a surface finger electrode connected to the surface bus bar electrode, micro cracks or the like further seriously occur in the silicon substrate 1 by stresses caused by the difference in thermal expansion between the solder and a copper composing the inner lead 8, the contraction, etc.

Furthermore, in recent years, from the viewpoint of cost reduction, an attempt to reduce a consumed amount of a semiconductor material by reducing the thickness of the silicon substrate 1 has been made. If the thickness of the silicon substrate 1 is reduced, the silicon substrate 1 is weakened against shock or stresses. If such stresses caused by the solder are applied, the frequency of occurrence of cracks is increased.

On the other hand, while an environmental problem is attached importance to, the effect of lead included in a Sn—Pb based eutectic solder on the human body is becoming a problem. A solder material called a lead-free solder including no lead has been actively examined. When a lead-free solder such as a Sn—Ag—Cu, Sn—Zn, Sn—Cu, or Sn—Ag—Ni based solder is used, however, stresses applied to a vicinity of the edges of the bus bar electrodes 5a easily become significant.

In a case where the coating with the solder is previously provided on the surface of the bus bar electrode, and the inner lead 8, together with the solder to be coated, is thermally welded, when the solder exists on the surface of the bus bar electrode, the thickness of the solder used for the welding is increased. Therefore, the stresses applied to the vicinity of the edges of the bus bar electrodes 5a easily become significant.

In order to solve such a problem, an Invar material composed of Fe—Ni or the like is employed for a copper foil to be coated in a Sn—Ag—Cu based solder to reduce the stresses. However, the resistance of a conductor is high, which leads to the loss of output.

Experiments conducted by the inventor have known that the stress which contracts by solidification of the solder for connecting the solar cell and the inner lead and the stress which contracts when the inner lead using a copper foil as a base material is cooled from the working temperature of the solder to room temperature are stored as internal stresses, and stored distortion is actualized as micro cracks in the vicinity of the boundary between the edge of the bus bar electrode and the solar cell whose intensity is the weakest and the semiconductor substrate.

An object of the present invention is to provide a solar cell module capable of reducing stresses applied to the vicinity of the boundary between an edge of a bus bar electrode in a solar cell and a semiconductor substrate and preventing defects such as micro cracks caused by the stresses from occurring.

### DISCLOSURE OF INVENTION

A solar cell module according to the present invention is so configured that a solder is not brought into contact with an edge along the longitudinal direction of a bus bar electrode and a portion from the edge to a predetermined distance inward therefrom so that the portion is brought into direct contact with a filler into which a solar cell connected by an inner lead is sealed.

The edge along the longitudinal direction of the bus bar electrode and the portion from the edge to a predetermined distance inward therefrom are coated with a coating member, for example, a solder resist so that the coating member may be brought into direct contact with the filler.

By these configurations, the portion is coated with the filler directly or through the coating member instead of being coated with a solder having high rigidity so that stresses applied to the portion are easily reduced. Therefore, it is possible to reduce tensile stresses applied to the vicinity of the boundary between a surface of a substrate in the solar cell and the edge of the bus bar electrode. Consequently, defects such as micro cracks can be prevented from occurring in the substrate near the bus bar electrode so that a craze in the subsequent process can be prevented. Stresses due to a daily temperature cycle in a case where a solar cell is installed outdoors are not concentrated in the vicinity of the electrode. Even if the solar cell is employed for a long time period, therefore, the portion near the bus bar electrode is hardly cracked.

Particularly in a configuration in which the edge along the longitudinal direction of the bus bar electrode and the portion from the edge to a predetermined distance inward therefrom are coated with the coating member, when the inner lead is thermally welded to the bus bar electrode, the portion in the bus bar electrode is coated with the coating member, thereby eliminating the possibility that the solder flows into the portion to cover the portion.

If the bus bar electrode is joined to the inner lead with the solder at its center portion in the transverse direction, the solder always exists particularly at the center portion of the bus bar electrode so that it is connected to the inner lead, thereby enhancing reliability in the connection.

If the width of the inner lead is smaller than the width of the bus bar electrode, it can be difficult for the solder in the inner lead to flow into an edge of the bus bar electrode when the inner lead is thermally welded to the bus bar electrode.

The solar cell further comprises a plurality of finger electrodes at least one ends of which are connected to the bus bar electrode. If the solar cell is brought into direct contact with the filler over the whole length such that the finger electrode and the inner lead are not connected to each other with the solder, stress concentrations between the finger electrode and the surface of the substrate can be restrained, thereby making it possible to prevent defects such as micro cracks from occurring in the substrate.

The one end, connected to the bus bar electrode, of the finger electrode may be coated with the coating member. Thus, if the position where the inner lead is connected is shifted in a case where the inner lead is thermally welded to the bus bar electrode, the one end of the finger electrode is covered with the coating member, thereby making it possible to prevent the finger electrode and the inner lead from being connected to each other with the solder.

If the coating member in the finger electrode also serves as a coating member in the bus bar electrode, the finger electrode and the bus bar electrode can be coated in one process, thereby making it possible to reduce the manufacturing cost of the solar cell module.

If the coating member in the finger electrode is a solder resist, the stresses are liable to be reduced, so that the coating member can be significantly easily formed.

In the solar cell module according to the present invention, a solder for connecting the inner lead and the bus bar electrode contains Sn and satisfies the following equation:
Σ(ViWi)<2.8(%)
(i denotes the number of elements composing the solder, Vi denotes the contraction coefficient (%) at the time of solidification of each of the elements composing the solder, Wi denotes the percentage by weight of each of the elements composing the solder (the whole is taken as 1), and the sum Σ takes 1 to i)

A value in the foregoing equation is the sum of the contraction coefficients (%) at the time of solidification of the elements composing the solder times the percentages by weight of the elements, and is a value related to the contraction coefficient at the time of solidification of the solder composed of a combination of the elements.

The contraction coefficient Vi at the time of solidification of each of the elements composing the solder is expressed by a ratio (V1−V2)/V at which the volume of the element is changed when phase transition from a melt state to a solid state occurs (V1: the volume at the time of a melt, and V2: the volume at the time of a solid). The contraction coefficient Vi indicates that the volume is decreased when it is a positive value, while indicating that the volume is increased when it is a negative value. In the present invention, the contraction coefficient may take a negative value, that is, the volume of the element may be increased.

If the inner lead using a copper foil as a base material and the bus bar electrode are joined to each other with the solder satisfying the foregoing range, the degree of contraction at the time of solidification of the solder is reduced, so that the stresses applied to the bus bar electrode can be reduced, as compared with that using the conventional solder. Consequently, defects such as micro cracks can be prevented from occurring in the substrate near the bus bar electrode so that a craze in the subsequent process can be prevented. Stresses due to a daily temperature cycle in a case where a solar cell is installed outdoors are not concentrated in the vicinity of the electrode. Even if the solar cell is employed for a long time period, therefore, the bus bar electrode is hardly cracked.

It is preferable that the solder contains Bi. Bi is a material whose volume is increased at the time of solidification, that is, whose contraction coefficient at the time of solidification takes a negative value. Therefore, the value in the foregoing equation Σ(ViWi) related to the contraction coefficient at the time of solidification of the solder containing Bi is reduced, thereby making it possible to reduce the stresses. Further, the conditions such as working temperature can be relaxed.

Furthermore, in a case where the content of Bi is 3 to 85% by weight, the stresses can be most satisfactorily reduced.

It is desirable that when the bus bar electrode is mainly composed of Ag, the solder contains 0.5 to 6.5% by weight of Ag. By such a configuration, the wettability of the bus bar electrode to the solder is increased. Even if Ag is used, therefore, an Ag leaching phenomenon by the solder can be restrained, thereby making it possible to enhance the reliability in the connection of the solder.

The solar cell module according to the present invention comprises a coupling wiring for connecting outer leads connected to ends of a plurality of solar cells which are connected to one another by an inner lead. The outer leads and the coupling wiring are electrically connected to each other with a solder mainly composed of tin, silver, and copper. The bus bar electrode and the inner lead are electrically connected to each other with a solder mainly composed of tin, bismuth, and silver.

The solder mainly composed of tin, silver, and copper is high in junction strength. Even if the stresses due to the temperature cycle are applied to a soldered portion between the outer leads and the coupling wiring, therefore, cracks or fractures hardly occur in the portion. The solder composed of tin, silver, and copper greatly contracts at the time of solidification. The solder having this composition is used in only the solar cell close to the end of the solar cell module and on the side of either one of the light receiving surface and the back surface of the solar cell. When pressure is applied to the solar cell connected in the subsequent manufacturing process of the solar cell module, therefore, the solar cells are hardly cracked or chipped.

A solder for connecting the inner lead and the bus bar electrode in the solar cell to each other is mainly composed of tin, bismuth, and silver. The solder hardly contracts at the time of solidification. When the bus bar electrode is connected by soldering, therefore, the solar cell does not warp. In the subsequent manufacturing process of the solar cell module, even when pressure is applied to the solar cell, the solar cell is hardly cracked or chipped.

If the composition of the solder mainly composed of tin, silver, and copper is 1.0 to 5.0% by weight of silver, 0.4 to 7.0% by weight of copper, and the remaining percent by weight of tin, the effect of reducing cracks or fractures from occurring in the portion even if the stresses due to the temperature cycle are applied can be made more reliable.

If the composition of the solder mainly composed of tin, bismuth, and copper is 20 to 60% by weight of bismuth, 0.5 to 5% by weight of sliver, and the remaining percent by weight of tin, the effect of reducing the occurrence of warping due to contraction at the time of solidification after soldering can be made more reliable.

### BRIEF DESCRIPTION OF DRAWINGS

FIG. 1 is a diagram showing the configuration in cross section of a solar cell X composing a solar cell module according to the present invention.

FIG. 2 (a) is a plan view showing an example of the shape of an electrode on the side of a light receiving surface (a surface) of a solar cell.

FIG. 2 (b) is a plan view showing an example of the shape of an electrode on the side of a non-light receiving surface (a back surface) of a solar cell.

FIG. 3 (a) is a cross-sectional view of a solar cell module Y configured by combining solar cells X.

FIG. 3 (b) is a partially enlarged sectional view of a solar cell module Y.

FIG. 4 is a diagram showing a connected state among solar cells composing a solar cell module.

FIG. 5 is a cross-sectional view taken along a line A-A shown in FIG. 3 (b) of a solar cell.

FIG. 6 is a cross-sectional view taken along a line A-A shown in FIG. 3 (b) in another embodiment of a solar cell.

FIG. 7 (a) is a partially cross-sectional view as viewed from a D-D direction shown in FIG. 2 (a) of a solar cell.

FIG. 7 (b) is a partially cross-sectional view as viewed from a D-D direction shown in FIG. 2 (a) showing another configuration of a solar cell.

FIG. 8 (a) is a partially enlarged plan view of a portion C shown in FIG. 2 (a).

FIG. 8 (b) is a partially enlarged plan view of the portion C shown in FIG. 2 (a) showing another structure of a solar cell.

FIG. 9 is a cross-sectional view taken along a line A-A shown in FIG. 2 (b) in a general solar cell X.

### BEST MODE FOR CARRYING OUT THE INVENTION

A solar cell module according to the present invention will be described in detail on the basis of the accompanying drawings.

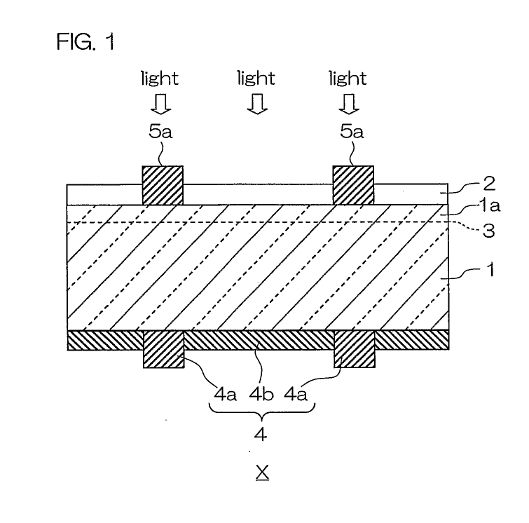

FIG. 1 is a diagram showing the configuration in cross section of a solar cell X composing a solar cell module according to the present invention.

In FIG. 1, reference numeral 1 denotes a p-type silicon substrate which is a semiconductor substrate, reference numeral 1a denotes an n-type diffusion layer in the p-type silicon substrate 1, reference numeral 2 denotes an anti reflection film formed on a surface of the p-type silicon substrate 1, and reference numeral 3 denotes a semiconductor junction surface.

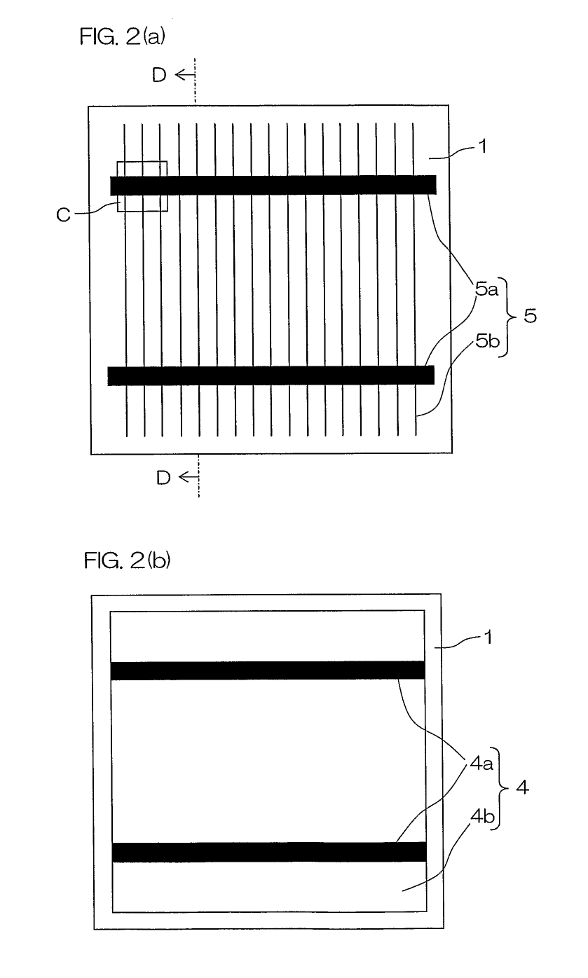

Reference numeral 4a denotes a back surface bus bar electrode, reference numeral 4b denotes a back surface current collecting electrode, reference numeral 5a denotes a surface bus bar electrode, and reference numeral 5b denotes a surface finger electrode (see FIG. 2 (a)). The surface bus bar electrode 5a and the surface finger electrode 5b may, in some cases, be collectively referred to as a “surface electrode 5”. The back surface bus bar electrode 4a and the back surface current collecting electrode 4b may, in some cases, be collectively referred to as a “back surface electrode 4”.

Here, the manufacturing process of the solar cell X will be described. First, a silicon substrate 1 composed of a p-type semiconductor such as single crystalline silicon or polycrystalline silicon is prepared. The silicon substrate 1 is a substrate containing approximately 1×10¹⁶˜1×10¹⁸ atoms/cm³ of semiconductor impurities such as boron (B) and having a specific resistance of approximately 1.0 to 2.0 Ω·cm. The silicon substrate 1 is formed by a pull-up method or the like when it is a single crystalline silicon substrate, while being formed by a casting method or the like when it is a polycrystalline silicon substrate. The polycrystalline silicon substrate can be mass-produced and is more advantageous than the single crystalline silicon substrate in terms of manufacturing cost.

A semiconductor ingot formed by the pull-up method or the casting method is cut to dimensions of approximately 10 cm×10 cm to 15 cm×15 cm and is sliced to a thickness of approximately 300 um to form the silicon substrate 1. Thereafter, in order to clean a cutting surface of the silicon substrate 1, the surface thereof is etched in trace amounts using a hydrofluoric acid, a fluorine nitric acid, etc.

The silicon substrate 1 is then arranged in a diffusion furnace, and is heat-treated in a gas including an impurity element such as phosphorus oxychloride (POCl₃), thereby diffusing a phosphorus atom on the surface of the silicon substrate 1 to form the n-type diffusion layer 1a having a sheet resistance of approximately 30 to 300 Ω/□. A boundary surface between the n-type diffusion layer 1a and the p-type semiconductor composing the silicon substrate 1 is the semiconductor junction surface 3.

The n-type diffusion layer 1a is left on only the surface of the silicon substrate 1, and the other portion is removed, followed by cleaning with ionized water. The n-type diffusion layer 1a is removed by applying a resist film on the surface of the silicon substrate 1 and etching away the n-type diffusion layer 1a on a back surface of the silicon substrate 1 using a mixed liquid of a hydrofluoric acid and a nitric acid. After the n-type diffusion layer 1a is etched away, the resist film is removed.

Furthermore, the anti reflection film 2 is formed on the surface of the silicon substrate 1. The anti reflection film 2 is composed of a silicon nitride film, for example. The silicon nitride film is formed by changing a mixed gas of silane (SiH₄) and ammonia (NH₃) into plasma by glow discharge decomposition and depositing the silicon substrate 1. This method is referred to as a plasma CVD method. The anti reflection film 2 is formed such that the refractive index thereof is approximately 1.8 to 2.3 in consideration of the difference in refractive index from the silicon substrate 1 and is formed to have a thickness of approximately 500 to 1000 Å. The anti reflection film 2 has a passivation effect when it is formed and has the effect of improving the electrical properties of a solar cell in conjunction with an anti reflection function.

The surface electrode 5 and the back surface electrode 4 are respectively formed on the surface and the back surface of the silicon substrate 1.

FIG. 2 (a) is a diagram showing the shape of the electrode on the side of a light receiving surface (surface) of the solar cell X, and FIG. 2 (b) is a diagram showing the shape of the electrode on the side of a non-light receiving surface (back surface) of the solar cell X.

The surface electrode 5 comprises the surface bus bar electrode 5a for extracting an output from the surface and the surface finger electrode 5b for current collection provided so as to be perpendicular thereto, as shown in FIG. 2 (a).

The back surface electrode 4 comprises the back surface bus bar electrode 4a and the back surface current collecting electrode 4b formed in a solid shape, for example, as shown in FIG. 2 (b)

In order to produce the surface bus bar electrode 5a, the back surface bus bar electrode 4a, and the surface finger electrode 5b, a silver paste produced in a paste shape by respectively adding 10 to 30 parts by weight and 0.1 to 5 parts by weight of an organic vehicle and a glass flit to 100 parts by weight of a silver powder is prepared. A portion, corresponding to the surface electrode 5, of the silicon substrate 1 having the anti reflection film 2 formed therein is etched away, the silver paste is printed thereon by a screen printing method, for example, is dried, and is then sintered at a temperature of 600 to 800° C. for 1 to 30 minutes. The silver paste may be first directly baked by a method called fire through on the anti reflection film 2.

The back surface current collecting electrode 4b is then formed so as to be on top at least of an edge portion of the back surface bus bar electrode 4a.

As the back surface current collecting electrode 4b, an aluminum paste produced in a paste shape by respectively adding 10 to 30 parts by weight and 0.1 to 5 parts by weight of an organic vehicle and a glass flit to 100 parts by weight of an aluminum powder is prepared. The aluminum paste is printed on a portion, including at least the edge portion of the back surface bus bar electrode 4a, of the silicon substrate 1 by a screen printing method, for example, and is dried. The aluminum paste is sintered at 600 to 800° C. for approximately one to thirty minutes after being dried, thereby baking aluminum on the silicon substrate 1. Consequently, the back surface current collecting electrode 4b is formed. At the time of the sintering, it is possible to prevent aluminum from being dispersed into the silicon substrate 1 to recombine carriers produced on the back surface.

The back surface bus bar electrode 4a and the back surface current collecting electrode 4b may be formed in the reverse order. Further, the back surface electrode 4 may have not the above-mentioned structure but a structure, comprising a bus bar electrode and a finger electrode, mainly composed of silver, similarly to the surface electrode 5.

Since electrical power generated by one solar cell produced in the foregoing manner is low, a plurality of solar cells must be connected in series and parallel to extract practical electrical output. A module constructed by connecting the plurality of solar cells in series and parallel is referred to as a solar cell module.

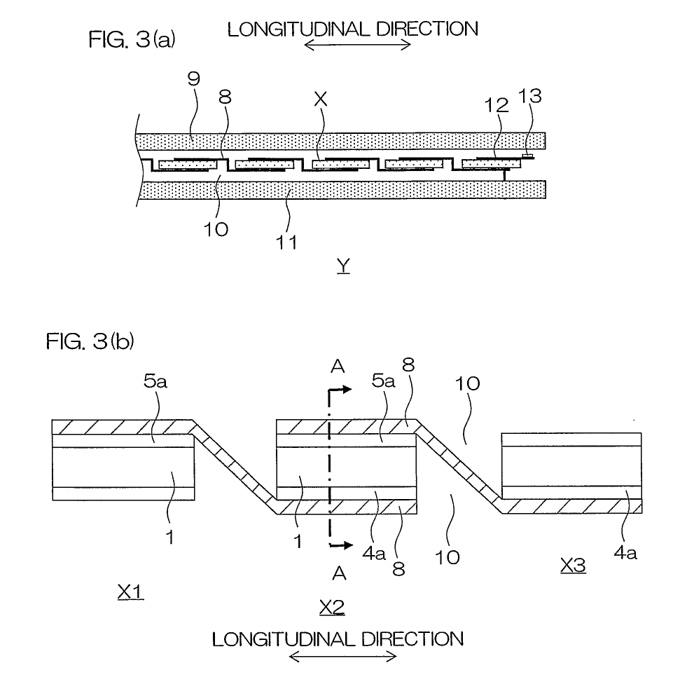

A cross-sectional view of a solar cell module Y is shown in FIG. 3 (a).

As shown in FIG. 3 (a), a plurality of solar cells X are electrically connected to one another by inner leads 8, and are interposed between a translucent panel 9 and a back surface protective material 11. A filler 10 mainly composed of an ethylene vinyl acetate copolymer (EVA) or the like is air-tightly sealed between the translucent panel 9 and the back surface protective material 11. The endmost solar cell X is connected to a coupling wiring 13 through an outer lead 12.

FIG. 3 (b) is a partially enlarged view of the internal configuration of the solar cell module Y shown in FIG. 3 (a). The plurality of solar cells X are indicated by X1, X2, and X3.

As shown in FIG. 3 (b), the surface bus bar electrode 5a in the solar cell X1 and the back surface bus bar electrode 4a in the adjacent solar cell X2 are connected to each other by the inner lead 8, and the surface bus bar electrode 5a in the solar cell X2 and the back surface bus bar electrode 4a in the adjacent solar cell X3 are connected to each other by the inner lead 8. In such a manner, the plurality of solar cells X are electrically connected to one another in series.

The inner lead 8 and the outer lead 12 are connected to the back surface bus bar electrode 4a and the surface bus bar electrode 5a by thermal welding such as hot-air welding over the whole length or at a plurality of portions of the back surface bus bar electrode 4a and the surface bus bar electrode 5a.

Examples of the inner lead 8 and the outer lead 12 are ones obtained by cutting a copper foil, having a thickness of approximately 100 to 300 μm, whose whole surface is coated with a solder having a thickness of 20 to 70 μm to a predetermined length.

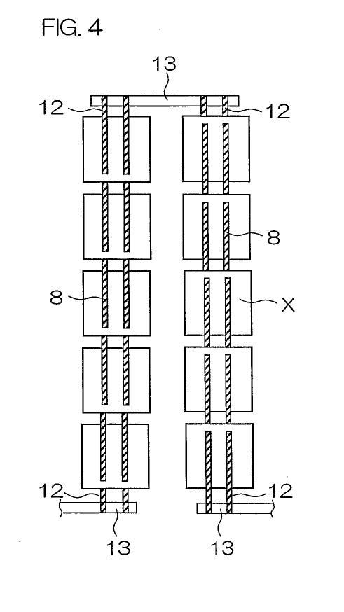

FIG. 4 is a plan view showing a connected state in the solar cell module Y. FIG. 4 illustrates a state where two strings each having the solar cells X linearly connected in series therein, as described above, are connected in series through a coupling wiring 13. In FIG. 4, the coupling wiring 13 couples outer leads 12 at respective ends of the strings to each other.

In the present invention, it is desirable that the inner lead 8 and the bus bar electrodes 4a and 5a in the solar cell X are connected to each other by not previously coating the surfaces of the bus bar electrodes 4a and 5a with a solder but melting a solder on the top surface of the inner lead 8.

Therefore, description is continued on the premise that the surfaces of the bus bar electrodes 4a and 5a are not coated with a solder, and the solder of the inner lead 8 is melted to achieve joining.

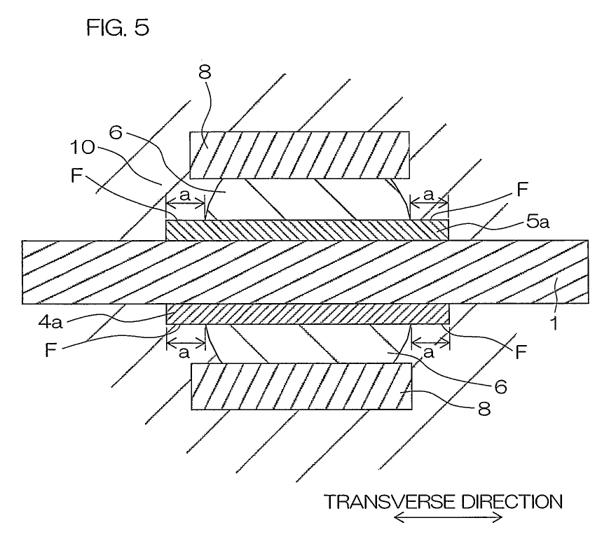

FIG. 5 is a cross-sectional view taken along a line A-A shown in FIG. 3 (b). The cross-sectional view is drawn by exaggerating the size of a principal part in order to make the configuration easy to understand, the dimensional ratio of which differs from the actual dimensional ratio.

As shown in the cross-sectional view of FIG. 5, in the present invention, edges along the longitudinal direction of the back surface bus bar electrode 4a and/or the surface bus bar electrode 5a and portions F from the edges to a predetermined distance a inward therefrom are not coated with a solder 6 but are brought into direct contact with the filler 10. Although the whole surfaces of the bus bar electrodes 4a and 5a have been conventionally coated with a solder 6 having high rigidity, the portions F are coated with the filler 10 instead in the present invention. Therefore, stresses applied to the bus bar electrodes 4a and 5a are easily reduced. Consequently, it is possible to reduce tensile stresses applied to the vicinities of the boundaries between the edges along the longitudinal direction of the bus bar electrodes 4a and 5a and the surface of the silicon substrate 1, and to restrain stress concentrations on the silicon substrate 1. This allows defects such as micro cracks to be prevented from occurring in the silicon substrate 1 near the bus bar electrodes 4a and 5a, thereby making it possible to prevent a craze in the subsequent manufacturing process.

In order that front portions F of the bus bar electrodes 4a and 5a are not thus coated with the solder, the inner lead 8 may be welded to only the center portions of the bus bar electrodes 4a and 5a when the bus bar electrodes 4a and 5a are connected to each other by the inner lead 8. If the width of the inner lead 8 is made smaller than the width of the bus bar electrodes 4a and 5a, for example, the edges along the longitudinal direction of the bus bar electrodes 4a and 5a and the portions F from the edges to a predetermined distance inward therefrom can be made difficult to cover with the solder 6 in the inner lead 8 when the inner lead 8 is thermally welded to the bus bar electrodes 4a and 5a.

Furthermore, a flux is applied to the center portions of the back surface bus bar electrode 4a and/or the surface bus bar electrode 5a, and no flux is applied to the portions F so that the center portions of the bus bar electrodes 4a and 5a can be coated with the solder 6 and the portions F cannot be coated with the solder 6.

Alternatively, only the center portions of the bus bar electrodes 4a and 5a may be previously coated with the solder.

In the present invention, it is desirable that the length a of the portion F from the edge, along the longitudinal direction of the bus bar electrode, which is brought into direct contact with the filler, to a predetermined distance inward therefrom is not less than 50 μm from the edge of the bus bar electrode in order to reduce the tensile stresses.

If the length a is too large, it is difficult to ensure connection between the bus bar electrodes 4a and 5a and the inner lead 8. That is, it is desirable that the bus bar electrodes 4a and 5a are joined to the inner lead 8 at least their center portions in order to sufficiently obtain connection strength between the bus bar electrodes and the inner lead. Consequently, the upper limit value of the length a differs depending on the size or the like of the bus bar electrode and is not uniquely determined. In the case of the bus bar electrode (the width thereof is approximately 2 mm) shown in an example, described later, however, the upper limit value may be one-fourth the width (i.e. 500 μm in the case of the width of the bus bar electrode is approximately 2 mm).

In the end, the length a of the edge along the longitudinal direction of the bus bar electrode and the portion F from the edge to a predetermined distance inward therefrom may satisfy the following expression:
50 μm<a<(one-fourth the width of the bus bar electrode)

When the inner lead 8 and the bus bar electrodes 4a and 5a are jointed at the center portion, all of the center portions are not necessarily joined.

It may, in some cases, be difficult to definitely judge the boundary between the substrate and the electrode because the edge of the electrode is thinned, similarly to an edge of an electrode formed using a printing and sintering method. In such a case, the length a of the portion F may be in the above-mentioned range by taking as an edge a portion where a main component on the endmost surface of the silicon substrate 1 is a material forming the electrode.

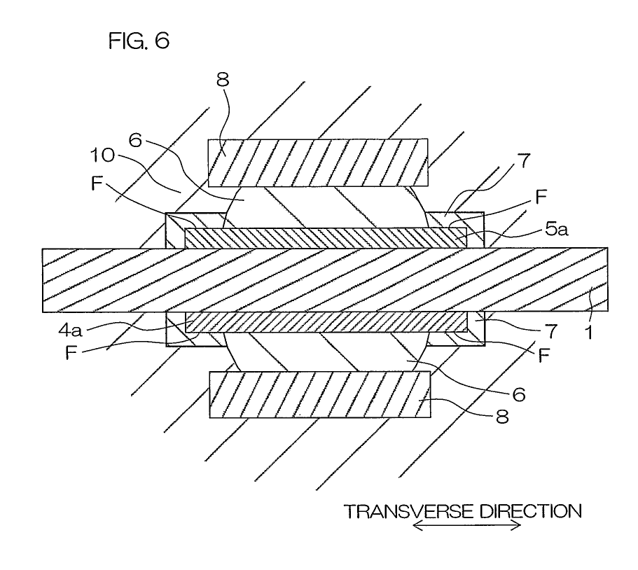

FIG. 6 illustrates another connecting structure between the inner lead 8 and the bus bar electrodes 4a and 5a. FIG. 6 is also a cross-sectional view taken along the line A-A shown in FIG. 3 (b), similarly to FIG. 5.

In the present embodiment, edges along the longitudinal direction of the back surface bus bar electrode 4a and/or the surface bus bar electrode 5a and portions F from the edges to a predetermined distance inward therefrom are coated with a solder resist 7. The portion F is brought into contact with the filler 10 in a state where the solder resist 7 is interposed therebetween.

Used as the solder resist 7 is organic cured resin. Examples of the organic cured resin include ultraviolet curing resin and thermosetting resin.

Since the portion F is thus brought into contact with the filler 10 through the solder resist 7, the portion F is coated with the solder resist 7 and the filler 10 instead of coating the whole upper surfaces of the bus bar electrodes 4a and 5a with the solder 6 having high rigidity as in the conventional example. Therefore, it is possible to reduce tensile stresses applied to the vicinities of the boundaries between the edges of the bus bar electrodes 4a and 5a and a surface of the silicon substrate 1, and alleviate stress concentrations on the silicon substrate 1, thereby making it possible to prevent defects such as micro cracks from occurring in the silicon substrate 1 positioned near the bus bar electrodes 4a and 5a.

In order to realize connection shown in FIG. 6, the edges along the longitudinal direction of the bus bar electrodes 4a and 5a and the portions F from the edges to a predetermined distance a inward therefrom are previously coated with the solder resist 7 and then, the inner lead 8 coated with the solder is thermally welded to the bus bar electrodes 4a and 5a. Even if the solder 6 flows into the bus bar electrodes 4a and 5a from the inner lead 8, therefore, the solder 6 does not cover the edges of the bus bar electrodes 4a and 5a.

If the width of the inner lead 8 is made smaller than that of the back surface bus bar electrode 4a and/or the surface bus bar electrode 5a, the portions F of the bus bar electrodes 4a and 5a can be made difficult to cover with the solder 6 in the inner lead 8 when the inner lead 8 is thermally welded to the bus bar electrodes 4a and 5a.

Further, by-coating flux on the center portion of the back surface bus bar electrode 4a and/or the surface bus bar electrode 5a, and by not coating flux on the portions F thereof, the center portion can be covered with the solder 6 whereas the portions F can be made not to be covered with the solder 6.

Description is made of a connecting structure between the inner lead 8 and the surface finger electrode 5b in the solar cell module according to the present invention.

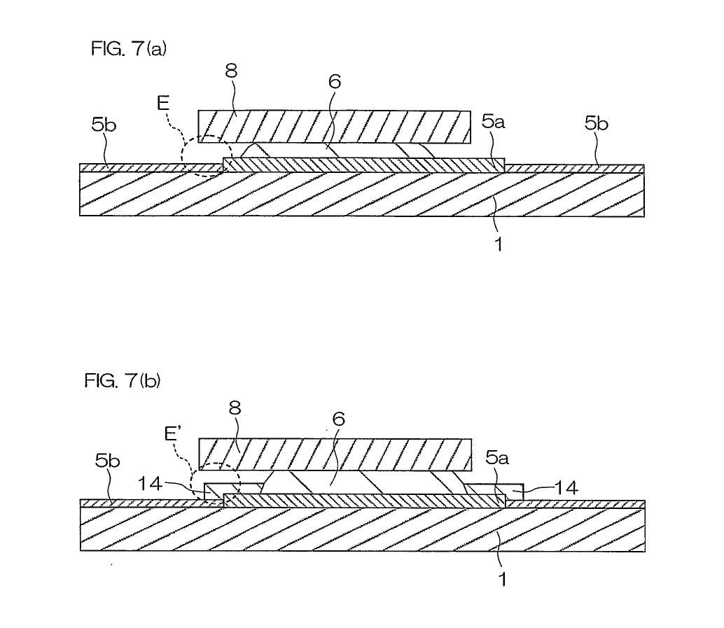

FIGS. 7 (a) and 7 (b) are partial cross-sectional views as viewed from a D-D direction shown in FIG. 2 (a), and the inner lead 8 is connected to the surface of the solar cell. The surface finger electrode 5b is illustrated in a form cut in the longitudinal direction.

The solar cell module has a plurality of surface finger electrodes 5b extending in a direction perpendicular to the surface bus bar electrode 5a, as shown in FIG. 2 (a). The surface finger electrode 5b has at least its end connected to the surface bus bar electrode 5a.

The present invention is characterized in that the surface finger electrode 5b and the inner lead 8 are not directly joined to each other. An area including the surface finger electrode 5b and the inner lead 8 is indicated by “E” in FIGS. 7 (a) and 7 (b).

In the area E, the inner lead 8 and the surface finger electrode 5b may be merely brought into contact with each other. The inner lead 8 and the surface finger electrode 5b may be spaced apart from each other by a predetermined distance determined depending on the shape and the arranged state of each of the members. In the process of air-tightly sealing the inner lead 8 and the surface finger electrode 5b with the filler 10 at the time of forming the solar cell module, the inner lead 8 and the surface finger electrode 5b may be spaced apart from each other through the filler 10 such as an EVA which has flowed. However, it is necessary that the inner lead 8 and the surface finger electrode 5b are not joined to each other with a solder.

FIGS. 7 (a) and 7 (b) illustrate a state where the inner lead 8 is shifted leftward as viewed from the front. The inner lead 8 thus frequently juts out onto the surface finger electrode 5b depending on the positional precision of a device for connecting the inner lead 8 with a solder (a tub attaching device).

As shown in FIG. 7 (a), the solder 6 which electrically connects the inner lead 8 and the surface bus bar electrode 5a to each other exists between the inner lead 8 and the surface bus bar electrode 5a. However, the inner lead 8 and the surface finger electrode 5b are not directly connected to each other with a solder. Since the inner lead 8 and the surface finger electrode 5b are not connected to each other with a solder, stress concentrations between the surface finger electrode 5b and the surface of the silicon substrate 1 can be restrained, thereby allowing defects such as micro cracks to occur in the silicon substrate 1.

In order to achieve a state where the inner lead 8 and the surface finger electrode 5b are not thus connected to each other with a solder, when a plurality of solar cells are thermally welded to one another by melting a solder using the inner lead 8, for example, a flux may be previously applied to the surface bus bar electrode 5a which is desired to be connected, and no flux may be applied to the surface finger electrode 5b. A portion to which a flux is applied is surface-activated by heating, and an oxide film is removed so that wettability to the solder is improved. On the other hand, in a portion to which no flux is applied, a surface oxide film cannot be removed so that wettability to the solder is bad. If no flux is applied to the surface finger electrode 5b, therefore, it is possible to obtain the configuration of the present invention in which the inner lead 8 and the surface finger electrode 5b are not connected to each other with a solder. Particularly, a clear effect is produced by connecting solar cells of a so-called solderless type in which surfaces of electrodes are not coated with a solder.

A solder may adhere to the surface finger electrode 5b itself. The effect of the present invention is produced if the inner lead 8 and the surface finger electrode 5b are not joined to each other with a solder.

As shown in FIG. 7 (b), a coating member 14 for coating the surface finger electrode 5b and the surface bus bar electrode 5a may be provided in a portion E′ where the surface finger electrode 5b is connected to the surface bus bar electrode 5a so that the inner lead 8 and the surface finger electrode 5b are not connected to each other with a solder.

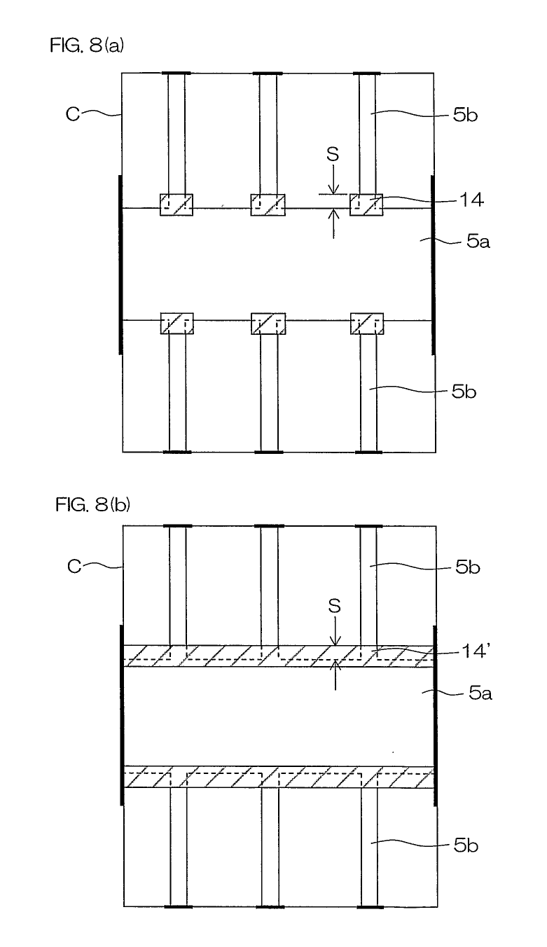

FIG. 8 (a) is a partially enlarged plan view of a portion C shown in FIG. 2 (a).

As shown in FIG. 8 (a), a portion where the surface finger electrode 5b is connected to the surface bus bar electrode 5a is coated with a coating member 14.

FIG. 8 (b) is a plan view showing a state where a portion where the surface finger electrode 5b is connected to the surface bus bar electrode 5a but also the whole edge along the longitudinal direction of the surface bus bar electrode 5a is coated with a coating member 14′.

In a case where the coating member 14 or 14′ is provided to thermally weld the inner lead 8 to the surface bus bar electrode 5a, even if the position where the inner lead 8 is connected is shifted, as shown in FIGS. 7 (a) and 7 (b), a part of the surface finger electrode 5b is covered with the coating member 14, thereby making it possible to prevent the surface finger electrode 5b and the inner lead 8 from being joined to each other with a solder. Consequently, stress concentrations between the surface finger electrode 5b and the surface of the substrate 1 can be restrained, thereby making it possible to prevent defects such as micro cracks from occurring in the silicon substrate 1.

It is desirable that the coating member 14 is composed of heat-resistant resin because heat is applied thereto in the processes of forming the solar cell module. Particularly if a solder resist is used, the surface finger electrode 5b is coated with the filler through the coating member 14 which is the solder resist. As a result, stresses are easily reduced.

Furthermore, the solder resist is desirable because the use thereof allows a coating member having a predetermined shape to be significantly easily formed by printing or photolithography and it has a resistance to a solder.

When the coating member 14′ is formed in a shape of FIG. 8 (b), the coating member 14′ can simultaneously have the function of the solder resist 7 for coating the portion along the edge of the surface bus bar electrode 5a, described in detail in the description of FIG. 6. Consequently, this is desirable in terms of cost because the coating member 14′ can be formed simultaneously with the solder resist 7 so that the number of processes can be reduced.

It is desirable that the length s of an area where the coating member 14 or 14′ is provided is in a range of not more than 5 mm from one end at which the surface finger electrode 5b is connected to the surface bus bar electrode 5a. The reason for this is that if the length s exceeds the range, the function of reducing conversion efficiency by blocking a light irradiation area becomes significant. As the lower limit value of the length s, the lower limit value may be set such that a range of the positional precision of a device for connecting the inner lead 8 with a solder (a tub attaching device), that is, a range in which the inner lead 8 may be shifted to jut out is reliably coated with a coating member.

Although description was made by limiting the finger electrode described in FIGS. 7 and 8 to that on the surface, it is desirable that when electrodes on the back surface are a bus bar electrode and a finger electrode mainly composed of silver, similarly to the electrodes on the surface, the finger electrode and the inner lead are not connected to each other with a solder in entirely the same way as those on the surface.

Description is made of the composition of a solder for joining the inner lead 8 and the back surface bus bar electrode 4a to each other and joining the inner lead 8 and the surface bus bar electrode 5a to each other in the solar cell module according to the present invention.

The inner lead 8 is a copper foil having a thickness of approximately 100 to 300 μm, and the whole surface thereof is coated with a solder having a thickness of approximately 20 to 70 μm.

In the present invention, selected as the solder with which the inner lead 8 is coated is a Sn based solder satisfying Σ(ViWi)<2.8 (%). Here, i denotes the number of elements composing the solder, Vi denotes the contraction coefficient (%) at the time of solidification of each of the elements composing the solder, Wi denotes the percentage by weight of each of the elements composing the solder (the whole is taken as 1), and the sum Σ takes 1 to i. A value in the foregoing equation is the sum of the respective percentages by weight of the elements composing the solder times the contraction coefficients (%) which are changes in volume in a case where there occurs phase transition of the elements from a melt to a solid.

The value in the foregoing equation is a value related to the contraction coefficient in a case where the solder composed by a combination of the elements is solidified.

Table 1 shows the contraction coefficient at the time of solidification of a single element generally known.

TABLE 1

| | CONTRACTION COEFFICIENT AT |
|---|---|
| ELEMENT | TIME OF SOLIDIFICATION (%) |
| Ag | 3.80 |
| Al | 6.00 |
| Au | 5.10 |
| Bi | −3.35 |
| Cu | 4.15 |
| Fe | 3.00 |
| Hg | 3.70 |
| Li | 1.65 |
| Mg | 4.10 |
| Na | 2.50 |
| Ni | 4.47 |
| Pb | 3.50 |
| Si | −9.60 |
| Sn | 2.80 |
| Ti | 3.65 |
| Zn | 4.20 |

For example, an Sn—Pb based solder generally used is an alloy obtained by mixing Sn and Pb at a weight ratio of approximately 6 to 4, and is a melt at a temperature of not less than approximately 183° C. which is an eutectic point. From Table 1, the contraction coefficient at the time of solidification of Sn is 2.8%, and the contraction coefficient at the time of solidification of Pb is 3.5%, so that the foregoing equation Σ(ViWi)=2.8×0.6+3.5×0.4=3.08 (%) (a value outside the scope of the present invention).

The inner lead 8 uses a copper foil (a coefficient of linear expansion: 1.62×10⁻⁵/K) as a base material, and is connected to the bus bar electrodes 4a and 5a by thermal welding such as hot-air welding in the vicinity of 200° C. which is working temperature. The inner lead 8 contracts only by approximately 0.3% when it is cooled to room temperature (approximately 20° C.). The contraction at the time of solidification of the Sn—Pb based solder conventionally used is added thereto, and an internal stress is stored inside the solder, which causes micro cracks to occur in the vicinities of the boundaries, which is the lowest in strength, between the bus bar electrodes 4a and 5a in the solar cell and the semiconductor substrate 1.

On the other hand, the inner lead 8 according to the present invention decreases in the contraction coefficient, by selecting a solder having a composition satisfying the relationship of the foregoing equation Σ(ViWi)<2.8, at the time of solidification of the solder at the time of cooling. As a result, tensile stresses in the vicinities of the boundaries between the bus bar electrodes 4a and 5a and the surface of the semiconductor substrate 1 are alleviated, thereby making it possible to prevent cracks in the vicinities of the electrodes in the solar cell module due to a daily temperature cycle stress.

The reason why the present invention thus produces an effect will be presumed as follows.

First, the contraction coefficient of the copper foil used as a base material in the inner lead 8 is very low, i.e., approximately one-tenth the contraction coefficient at the time of solidification of the solder. In a time period during which the temperature of the solder is reduced from a melting point (e.g., 200° C. which is working temperature) to an eutectic point (183° C.), distortion energy at the time of solidification of the solder should be normally consumed by the viscosity of the solder without being stored. However, the viscosity of the solder gradually rises as the temperature of the solder comes closer to the eutectic point, or a melt slightly deviates from a complete eutectic composition, so that the melt and a deposited crystal coexist. While the phase transition from the melt to a solid occurs, therefore, the distortion energy due to contraction at the time of solidification is not completely absorbed and stored.

It is considered that the distortion due to the contraction at the time of solidification of the solder is added to distortion due to contraction at the time of cooling of the inner lead 8. The stresses may be prevented from being reduced due to the existence of a hard and fragile intermetallic compound, for example, a η phase (Cu₆Sn₅) or a E phase (Cu₃Sn) formed on the interface upon reaction of a copper which is a base material of the inner lead 8 and a component (Sn) of the solder.

The value in the foregoing equation (ViWi) is the sum of the respective percentages by weight of the elements composing the solder times the contraction coefficients (%) at the time of solidification of the elements, and is a virtual value found on the assumption that a linear relationship holds among the elements composing the solder. Since an actual solder is a eutectic alloy of a replacement type solid solution, for example, and parts of metal elements are segregated due to a slight shift in composition, a linear relationship does not strictly hold. However, the inventors have found as the result of an experiment that the virtual value is very deeply related to a contraction coefficient in a case where a solder composed of a combination of the elements is solidified in the scope of the present invention. Even if measurements are not actually made, the value is compared, thereby making it possible to judge whether or not the solder is proper for applications of the present invention.

A solder satisfying the foregoing conditions may be selected out of solders having combinations of elements in which a suitable melting point is obtained while referring to Table 1 in solders having compositions containing Sn, such as Sn—Ag, Sn—Ag—Cu, Sn—Bi, Sn—Bi—Ag, Sn—Cu—Bi, Sn—Cu, Sn—Zn—Bi, and Sn—Sb based solders.

Particularly, the solders containing Bi out of the solders having the above-mentioned compositions are desirable. The reason for this is that Bi is a material whose volume is increased (by −3.35%) when it is solidified similarly to water or the like, so that the contraction coefficient at the time of solidification can be reduced by containing Bi in the above-mentioned solder to satisfy the relationship of the foregoing equation Σ(ViWi)<2.8 related to the contraction coefficient at the time of solidification.

Out of materials, together with Sn, forming solder alloys, the material, whose volume is increased at the time of solidification, other than Bi is not known, so that a significantly subtle composition is required in a configuration containing no Bi. It is easy to contain Bi to obtain a solder containing no Pb, thereby making it possible to provide a solar cell module considering a natural environment.

It is desirable that the content of Bi is 3 to 85% by weight of the whole solder. In the above-mentioned range, the stresses can be reduced most satisfactorily. In addition thereto, the working temperature can be reduced because a eutectic composition is formed between Sn and Bi.

It is desirable that in a case where the back surface bus bar electrode 4a and the surface bus bar electrode 5a mainly composed of Ag having a low resistance are used, the solder contains 0.5 to 6.5% by weight of Ag. The reason for this is that such an Ag leaching phenomenon that silver (Ag) is acquired in the solder during working by containing Ag in the solder can be restrained to enhance the reliability of connection of the solder.

The effect of improving wettability cannot be sufficiently obtained when the content of Ag in the solder is lower than 0.5% by weight, while if Ag is more than 6.5% by weight, the deposition amount of brittle Ag₃Sn is increased in the interfaces of the solder and the bus bar electrodes 5a and 4a so that the solder is weakened against shock. Therefore, it is desirable that the content of Ag is not less than 0.5% by weight or more than 6.5% by weight.

As described in the foregoing, it is desirable that used as the inner lead 8 is one coated with a solder mainly composed of tin, bismuth, and silver, excluding trace amounts of impurities.

The solder composed of tin, bismuth, and silver is relatively low in melting point as a solder containing no lead, and further hardly contracts at the time of solidification after cooling. Therefore, there is little difference in coefficient of thermal expansion between the inner lead 8 and the substrate 1 and hardly warps after soldering by contraction at the time of solidification.

In order to produce such an inner lead 8, a copper foil or the like is previously dipped in a solder tub, to coat one surface of the copper foil with a solder having a thickness of approximately 20 to 70 microns and cut the copper foil to a suitable length.

The composition of the solder composed of tin, bismuth, and silver is 20 to 60% by weight of bismuth, 0.5 to 5% by weight of silver, and the remaining percent by weight of tin (e.g., 42% by weight of tin, 57% by weight of bismuth, and 1% by weight of silver).

Thus, according to the present invention, it is possible to reduce tensile stresses applied to the vicinities of the boundaries between ends of the bus bar electrodes 5a and 4a and the surface of the silicon substrate 1 by selecting the composition of the solder such that the contraction coefficient at the time of solidification is a low value, and to restrain stress concentrations. Therefore, it is possible to prevent defects such as micro cracks from occurring in the silicon substrate 1 near the bus bar electrodes 5a and 4a. Stresses due to a daily temperature cycle in a case where the solar cell is installed outdoors are not concentrated in the vicinities of the bus bar electrodes, so that the bus bar electrodes are not cracked even if they are employed for a long time period.

Furthermore, if it is assumed that the solder with which the inner lead 8 is coated is Bi, it can be a solder containing no Pb, thereby making it possible to provide a solar cell module considering a natural environment.

In the present invention, the surfaces of the bus bar electrodes 5a and 4a in the solar cell X are previously coated with not a solder but a flux so that the bus bar electrodes 5a and 4a in the solar cell X and the inner lead 8 may be connected to each other by only the solder with which the inner lead 8 is coated by melting the solder, which has not been particularly referred to in the foregoing description.

Description is now made of the composition of a solder for connecting the coupling wiring 13 between the strings, described using FIG. 4.

Although the coupling wiring 13 is produced by a metal having good conductivity, such as silver, copper, aluminum, or iron, it is suitably produced by copper in consideration of its conductivity and easiness of coating with a solder. Although the thickness and the width of the coupling wiring 13 are determined in consideration of an output of the solar cell module, for example, the thickness and the width are respectively approximately 0.2 to 1.0 mm and 3 to 8 mm in many cases.

It is desirable that substantially the whole surface of the coupling wiring 13 is previously coated with a solder mainly composed of tin, silver, and copper.

More specifically, a solder having a composition of 1.0 to 5.0% by weight of silver, 0.4 to 7.0% by weight of copper, and the remaining percent by weight of tin is effective because it produces a large effect.

For example, solders (a) 98.5% of tin, 1% of silver, and 0.5% of copper, (b) 97.5% of tin, 2% of silver, and 0.5% of copper, (3) 95% of tin, 1% of silver, and 4% of copper, (4) 96.5% of tin, 3% of silver, and 0.5% of copper, and (5) 92% of tin, 2% of silver, and 6% of copper are used.

The reason for this is that the solder mainly composed of tin, silver, and copper is high in junction strength, so that a joint portion is hardly cracked or fractured even if stresses due to a temperature cycle are applied to a soldered portion of the outer lead 12 and the coupling wiring 13. Consequently, it is possible to prevent the output of the solar cell module from being reduced.

The solder composed of tin, silver, and copper is relatively high in the value in the foregoing equation Σ(ViWi) or the contraction coefficient at the time of solidification. However, even if the solder composed of tin, silver, and copper is used in the coupling wiring 13, the portion connected to the coupling wiring 13 is only the outer lead 12 on the front or the back side of the solder cell element. Therefore, the solar cell is hardly cracked or chipped.

The outer lead 12 and the coupling wiring 13 are used by previously dipping a copper foil or the like in a solder tub to coat one surface of the copper foil with a solder having a thickness of 20 to 70 microns and cut the copper foil to a suitable length.

The embodiment of the present invention is not limited to only the above-mentioned example. Various changes can be made in a range which does not depart from the gist of the present invention.

For example, the number or figure of the bus bar electrode and finger electrode is not limited to the ones above-described. The bus bar electrode is connected to the inner lead, and electrodes connected to the bus bar electrode are finger electrodes for collection of electric power.

Although description was made by an example in which one end of the surface finger electrode 5b is connected to the surface bus bar electrode 5a so as to be substantially perpendicular thereto, it may be connected from an oblique direction without being perpendicular thereto. Further, both ends of the surface finger electrode 5b may be connected to the surface bus bar electrode 5a to have a closed shape.

Although description was made of the solar cell using the p-type silicon substrate, the configuration of the present invention can be obtained by the same processes even in a case where an n-type silicon substrate is used if the polarity in the description is reversed. Although description was made of the case of the single junction type solar cell, the present invention is also applicable to a multi-junction type solar cell in which a semiconductor multilayer film is stacked on a bulk substrate.

Although description was made by taking as an example the polycrystalline silicon substrate using the casting method, the substrate need not be limited to the one using the casting method. A material composing the substrate need not be limited to polycrystalline silicon or is not limited to a silicon material. It is applicable to semiconductors in general. This is, the present invention is also applicable to solar cells using compound and organic semiconductors.

### EXAMPLE 1

A damage layer on a surface of a p-type polycrystalline silicon substrate 1 having an outer shape of 15 cm×15 cm and having a relative resistance of 1.5 Ω·cm was etched and cleaned by an alkali. The silicon substrate 1 was then arranged in a diffusion furnace, and was heated in phosphorous oxychloride (POCl₃), thereby diffusing a phosphorous atom on the surface of the silicon substrate 1 so as to have a concentration of 1×10¹⁷ atoms/cm³, to form an n-type diffusion layer 1a. A silicon nitride film having a thickness of 850 Å serving as an anti reflection film 2 was formed thereon by a plasma CVD method.

In order to form a back surface current collecting electrode 4b on a back surface of the silicon substrate 1, an aluminum paste produced in a paste shape by respectively adding 20 parts by weight and 3 parts by weight of an organic vehicle and a glass flit to 100 parts by weight of an aluminum powder was applied and dried by a screen printing method. In order to form a back bus bar electrode 4a on the back surface of the silicon substrate 1 and form a surface electrode 5 (a surface bus bar electrode 5a and a surface finger electrode 5b) on the surface thereof, a silver paste produced in a paste shape by respectively adding 20% by weight and 3% by weight of an organic vehicle and a glass flit to 100 parts by weight of a silver powder was applied and dried by a screen printing method, followed by baking at 750° C. for 15 minutes, to simultaneously form the surface bus bar electrode 5a and the back surface bus bar electrode 4a on the surface and the back surface so as to have a width of 2 mm.

Here, as a sample No. 1, a solder resist 7 was printed on a portion F including an edge of the surface bus bar electrode 5a and dried, and the electrode was coated with a solder 6 by a dipping method, to form a solar cell shown in FIG. 7.

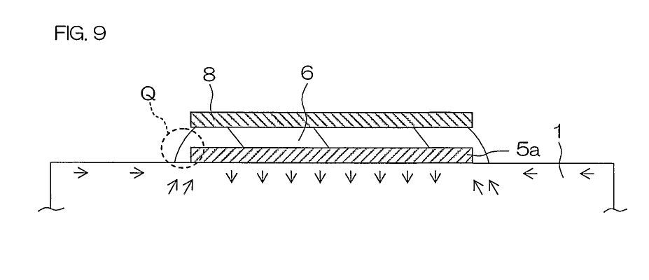

As a sample No. 2, the whole surface of the surface bus bar electrode 5a was similarly coated with a solder 6 by a dipping method without using a solder resist 7, to form a solar cell in the conventional form shown in FIG. 9. A Sn-3Ag-0.5Cu based Pb-free solder was used as the solder 6.

As a sample No. 3, a solder paste was applied to only the center portions in the transverse direction of the bus bar electrodes 4a and 5a using a dispenser without using a solder resist 7, to form a solar cell.

Furthermore, as samples No. 4 and No. 5, samples in which electrodes are not coated with a solder 6 were produced.

With respect to the above-mentioned solar cells No. 1 to No. 5, an inner leads 8 made of a copper foil having a width of 1.8 mm and having a thickness of 200 μm provided with a solder layer having a thickness of approximately 30 μm were affixed by thermal welding such as hot-air welding over the respective whole lengths of the bus bar electrodes 4a and 5a, to connect and wire solar cells.

At this time, in the samples No. 3 and No. 4, only at the center portion of the inner lead 8 was fixed by thermal welding.

In the sample No. 5, used as the inner lead 8 was one whose width is 2.2 mm, which is larger than the width of the electrode to be connected. The inner lead 8 was thermally welded to the whole surface of the electrode.

Thereafter, the solar cell module having the cross-sectional structure shown in FIG. 3 (a) was formed by connecting and wiring the solar cells, described above, and sealing the solar cells as a filler 10 between a translucent panel 9 and a back surface protective material 11 using an EVA (an ethylene vinyl acetate copolymer), as shown in FIG. 3 (a).

With respect to the solar cells, a breaking strength test by four-point bending was conducted, to find breaking strength (N).

Furthermore, the rate of incidence of micro cracks in the solar cells sealed in a static load test in which a pressure of 3000N/m² is applied was examined in the solar cell module Y. The “rate of incidence of micro cracks” was examined using a binocular microscope of 40 times power, and represents the ratio of the number of solar cells X in which micro cracks occurred to the total number of all the solar cells X in the solar cell module Y used for the static load test.

The results are shown in Table 2.

TABLE 2

| | | | | | RESULTS | | |
|---|---|---|---|---|---|---|---|
| | CONDITIONS | | | | | RATE OF | |
| | ELECTRODE | | INNER | RESIST AT | BREAKING | INCIDENCE | |
| SAMPLE | SOLDER | ELECTRODE | LEAD | ELECTRODE | STRENGTH | OF MICRO | |
| No. | COATING | WIDTH | WIDTH | END | (N) | CRACKS | REMARKS |
| 1 | ◯ | 2 mm | 1.8 mm | ◯ | 25 | 0% | PRESENT |
| | COATING AT | | | | | | INVENTION |
| | ONLY | | | | | | |
| | CENTER | | | | | | |
| 2 | ◯ | 2 mm | 1.8 mm | X | 15 | 50% | OUTSIDE |
| | WHOLE | | | | | | SCOPE OF |
| | COATING | | | | | | PRESENT |
| | | | | | | | INVENTION |
| 3 | ◯ | 2 mm | 1.8 mm | X | 23 | 0% | PRESENT |
| | COATING AT | | | | | | INVENTION |
| | ONLY | | | | | | |
| | CENTER | | | | | | |
| 4 | X | 2 mm | 1.8 mm | X | 24 | 0% | PRESENT |
| | INNER LEAD | | | | | | INVENTION |
| | CENTER | | | | | | |
| | WELDING | | | | | | |
| 5 | X | 2 mm | 2.2 mm | X | 15 | 40% | OUTSIDE |
| | INNER LEAD | | | | | | SCOPE OF |
| | WHOLE | | | | | | PRESENT |
| | WELDING | | | | | | INVENTION |

The sample No. 1 is a sample having the configuration shown in FIG. 6 in the present invention with the solder resist 7 interposed between the edge along the longitudinal direction of the surface bus bar electrode 5a and the EVA which is the filler 10. The breaking strength was 25 N, and the rate of incidence of micro cracks was 0%, so that the effect of the invention was confirmed.

The sample No. 2 is a sample outside the scope of the present invention in which the edges of all the bus bar electrodes 4a and 5a are coated with the solder 6, and are not brought into direct contact with the EVA which is the filler 10 or are not brought into contact therewith through the solder resist 7. The breaking strength was 15 N, and the rate of incidence of micro cracks was 50%, which were unsatisfied results.

The sample No. 3 is a solar cell module completed as a result of coating only the center portions of the bus bar electrodes 4a and 5a with the solder 6 to weld the center portion of the inner lead 8. The sample has the form shown in FIG. 5 according to the present invention in which the edges of the bus bar electrodes and the filler 10 are brought into direct contact with each other. In this case, the breaking strength of the solar cell was 23 N, and the rate of incidence of micro cracks was 0%, so that the effect of the invention was confirmed.

The sample No. 4 is a sample in which the bus bar electrodes 4a and 5a are not coated with the solder 6. A solar cell module completed as a result of utilizing the solder with which the inner lead 8 is coated to weld the center portion of the inner lead 8 has the form shown in FIG. 5 according to the present invention in which the edges of the electrodes and the filler 10 are brought into direct contact with each other. In this case, the breaking strength of the solar cell was 24 N, and the rate of incidence of micro cracks was 0%, so that the effect of the invention was confirmed.

The sample No. 5 is a sample in which the bus bar electrodes 4a and 5a are not coated with the solder 6, and has a configuration outside the scope of the present invention in which the edges of the bus bar electrodes 4a and 5a are coated with the solder 6 when the whole surface is welded by hot air using the inner lead 8 having a width of 2.2 mm larger than the width of the bus bar electrodes 4a and 5a, so that the edges of the electrodes and the filler 10 are not brought into direct contact with each other. As a result, the breaking strength was 15 N, and the rate of incidence of micro cracks was 40%, which were unsatisfied results.

Thus, according to the present invention, the edges of the bus bar electrodes 4a and 5a were not coated with the solder 6 but were brought into contact with the filler 10 directly or through the solder resist 7, thereby confirming that stress concentrations in the vicinities of the boundaries between the edges of the bus bar electrodes and the surface of the substrate could be restrained, so that the breaking strength was increased, and the occurrence of micro cracks in the substrate near the bus bar electrodes could be restrained.

### EXAMPLE 2

Solar cells were formed in the same manner as that in the example 1. Thereafter, a solder resist was printed and applied with a pattern shown in FIG. 8 (b) to an area, on the side of a surface finger electrode 5b from one end at which the surface finger electrode 5b is connected to a surface bus bar electrode 5a to a distance of 1 mm therefrom and was thermoset, to form a coating member 14′. Thereafter, the inner lead 8 using a copper foil coated with a solder was thermally welded. In this case, an attempt to intentionally shift the position of the inner lead 8 to make the inner lead 8 jut out of the surface bus bar electrode 5a to intentionally connect them with a solder is made. However, with respect to a sample in which the coating member 14′ which is a solder resist is provided, they were not connected to each other in any way. Further, with respect to a sample in which the coating member 14′ is not provided, they are joined to each other in a case where a flux is applied to the surface finger electrode 5b. Used as the solder with which the copper foil is coated is a Sn-3Ag-0.5Cu based Pb-free solder.

A sample No. 6 is a sample in which the coating member 14′ is not provided, and the inner lead 8 is not shifted from the surface bus bar electrode 5a. A sample No. 7 is a sample in which the coating member 14′ is provided, and the inner lead 8 is not shifted from the surface bus bar electrode 5a. Samples No. 8 and No. 9 are samples in which the coating member 14′ is not provided, and the inner lead 8 is shifted 0.3 mm from the surface bus bar electrode 5a. A sample No. 10 is a sample in which the coating member 14′ is provided, and the inner lead 8 is shifted 0.3 mm from the surface bus bar electrode 5a. Samples No. 11 and No. 12 are samples in which the coating member 14′ is not provided, and the inner lead 8 is shifted 0.5 mm from the surface bus bar electrode 5a. A sample No. 13 is a sample in which the coating member 14′ is provided, and the inner lead 8 is shifted 0.5 mm from the surface bus bar electrode 5a.

With respect to the samples No. 6 to No. 13 thus produced, evaluations were carried out by the rate of incidence of micro cracks described in the example 1. The results are shown in Table 3.

TABLE 3

| | | | CONNECTION | |
|---|---|---|---|---|
| | | | WITH SOLDER | |
| | | PRESENCE | BETWEEN | RATE OF |
| | SHIFT IN | OR | INNER LEAD | INCIDENCE |
| | INNER LEAD | ABSENCE | AND FINGER | OF CRACKS |
| No. | (mm) | OF RESIST | ELECTRODE | (%) |
| 6 | 0 | x | x | 0 |
| 7 | 0 | ∘ | x | 0 |
| 8 | 0.3 | x | x | 0 |
| 9 | 0.3 | x | ∘ | 30 |
| | | | USE OF FLUX | |
| 10 | 0.3 | ∘ | x | 0 |
| 11 | 0.5 | x | x | 0 |
| 12 | 0.5 | x | ∘ | 50 |
| | | | USE OF FLUX | |
| 13 | 0.5 | ∘ | x | 0 |

In the samples No. 6 and No. 7, the inner lead 8 is not shifted from the surface bus bar electrode 5a. Connection with a solder was not made between the inner lead 8 and the surface finger electrode 5b irrespective of the presence or absence of the coating member 14′ which is a solder resist so that no cracks occurred.

The samples No. 8 to No. 10 in which the inner lead 8 is shifted 0.3 mm toward the surface finger electrode 5b are as follows:

In a case where the coating member 14′ which is a solder resist is provided (sample No. 10), no connection with a solder was made between the inner lead 8 and the surface finger electrode 5b so that no cracks occurred.

In a case where the coating member 14′ which is a solder resist is not provided, when a flux was applied to the surface finger electrode 5b to intentionally make connection with a solder between the inner lead 8 and the surface finger electrode 5b (sample No. 9), the rate of incidence of micro cracks was 30%. In a case where no flux was applied (sample No. 8, no connection with a solder was made between the inner lead 8 and the surface finger electrode 5b so that no cracks occurred.

The samples No. 11 to No. 13 where the inner lead 8 is shifted 0.5 mm toward the surface finger electrode 5b are as follows:

In a case where the coating member 14′ which is a solder resist is provided (sample No. 13), no connection with a solder was made between the inner lead 8 and the surface finger electrode 5b so that no cracks occurred. In a case where the coating member 14′ which is a solder resist was not provided, when a flux was applied to the surface finger electrode 5b to intentionally make connection with a solder between the inner lead 8 and the surface finger electrode 5b (sample No. 12), the rate of incidence of micro cracks was 50%. In a case where no flux was applied (sample No. 11), however, no connection with a solder was made between the inner lead 8 and the surface finger electrode 5b so that no cracks occurred.

### EXAMPLE 3

Solar cells were formed in the same manner as that in the example 1.

An inner lead 8 using a copper foil having a width of 2 mm and having a thickness of 200 μm which is provided with a solder layer having a thickness of approximately 30 μm was then affixed by thermal welding such as hot-air welding over the whole lengths of bus bar electrodes 5a and 4a to which a flux was applied, to connect and wire the above-mentioned solar cells.

At this time, the composition of the solder was changed into a plurality of types of compositions. Solders used for samples No. 21 to 28 are ones composed of 1 to 90% by weight of Bi, 2% by weight of Ag, and the remaining percent by weight of Sn. Solders used for samples No. 29 to 32 are ones composed of 50% by weight of Bi, 0.1 to 9% by weight of Ag, and the remaining percent by weight of Sn. A solder in a sample No. 33 has a composition of Sn-5Ag-0.5Cu, a solder in a sample No. 34 has a composition of Sn-5Ag-0.5Cu, and a solder in a sample No. 35 has a composition of Sn-0.4Pb.

In only the sample No. 34, an inner lead with an Invar material composed of Fe-36Ni held in a copper foil was used at the center portion of the copper foil. In the other samples, an inner lead using a copper foil was used.

Each of the samples was selected while considering whether or not Σ(ViWi)<2.8 (Vi; the contraction coefficient (%) at the time of solidification of each of elements composing a solder, and Wi; the percentage by weight of the element composing the solder (the whole is taken as 1)) was satisfied.

Thereafter, the inner lead 8 was affixed to the bus bar electrodes 5a and 4a on both a surface and a back surface of each of the solar cells to connect and wire the solar cells, and the solar cells were sealed using an EVA (an ethylene vinyl acetate copolymer) as a filler 10 between a translucent panel 9 and a back surface protective material 11, as shown in FIG. 3 (b), to form a solar cell module.

Electrical properties were measured under conditions of 25° C. and Am-1.5 using a solar simulator, and yield at the time of manufacturing the solar cell module was found.

TABLE 4

| | TYPE OF SOLDER | | | | | | | | |
|---|---|---|---|---|---|---|---|---|---|
| SAMPLE | (% BY WEIGHT) | | | | Isc | Voc | | Pm | YIELD |
| No. | Bi | Ag | Sn | Σ (ViWi) | (A) | (V) | FF | (W) | (%) |
| 21 | 1 | 2 | REMAING | 2.76 | 7.658 | 0.601 | 0.719 | 3.309 | 90.3 |
| 22 | 3 | | PERCENT | 2.64 | 7.662 | 0.602 | 0.721 | 3.326 | 94.8 |
| 23 | 29 | | | 1.04 | 7.686 | 0.603 | 0.725 | 3.360 | 98.3 |
| 24 | 50 | | | −0.26 | 7.780 | 0.604 | 0.724 | 3.402 | 99.6 |
| 25 | 57 | | | −0.69 | 7.680 | 0.603 | 0.726 | 3.362 | 99.4 |
| 26 | 70 | | | −1.49 | 7.668 | 0.602 | 0.724 | 3.342 | 98.5 |
| 27 | 85 | | | −2.41 | 7.664 | 0.602 | 0.724 | 3.340 | 93.1 |
| 28 | 90 | | | −2.72 | 7.661 | 0.602 | 0.722 | 3.330 | 90.7 |
| 29 | 50 | 0.1 | | −0.27 | 7.647 | 0.601 | 0.712 | 3.272 | 99.7 |
| 30 | | 0.5 | | −0.27 | 7.654 | 0.601 | 0.717 | 3.298 | 98.6 |
| 31 | | 6.5 | | −0.21 | 7.664 | 0.602 | 0.723 | 3.336 | 95.1 |
| 32 | | 9 | | −0.19 | 7.658 | 0.602 | 0.721 | 3.324 | 90.2 |

| | | | | | | | | |
|---|---|---|---|---|---|---|---|---|
| ※ | 33 | Sn—5Ag—0.5Cu | 2.86 | 7.662 | 0.601 | 0.718 | 3.306 | 69.6 |
| ※ | 34 | Sn—5Ag—0.5Cu (Cu-(INVAR)-Cu) | 2.86 | 7.597 | 0.600 | 0.696 | 3.173 | 94.8 |
| ※ | 35 | Sn—Pb | 3.08 | 7.687 | 0.603 | 0.722 | 3.347 | 85.5 |

※ IS A SAMPLE OUTSIDE SCOPE OF PRESENT INVENTION

From Table 4, the samples No. 33 to No. 35 are samples outside the scope of the present invention in which the conditions Σ(ViWi)<2.8 according to the present invention were not satisfied. Any of the samples was inferior in solar cell properties or yield, which were unsatisfied results.

On the other hand, the samples No. 21 to No. 32 using a copper foil coated with an Sn—Bi—Ag based solder satisfying the conditions Σ(ViWi)<2.8 according to the present invention were superior in solar cell properties, and the yields thereof were not less than 90%. Particularly, with respect to the samples No. 22 to No. 27 in which the content of Bi was 3 to 85% by weight, it was confirmed that the yield of the solar cell module was not less than 93%, and the electrical properties thereof were not degraded, so that the effect of the present invention was satisfactorily produced.

Furthermore, with respect to the sample No. 21 or No. 28, the working temperature was raised depending on the content of Bi, so that it was considered that the yield was slightly degraded by thermal stresses.

With respect to the sample No. 29, the content of Ag was 0.1% by weight, so that wettability to an electrode portion was not improved. Therefore, it was considered that adhesion between the inner lead and the bus bar electrode was weak, so that electrical properties were slightly degraded.

Furthermore, with respect to the sample No. 32, the content of Ag was 9% by weight. Therefore, it was considered that the yield was slightly degraded because brittle Ag₃Sn was deposited.

1. A solar cell module comprising a plurality of solar cell elements in a flat plate shape, and an inner lead for electrically connecting a bus bar electrode provided on a light receiving surface of one of the solar cell elements and a bus bar electrode provided on a non-light receiving surface of the other solar cell element adjacent thereto, wherein
the solar cell elements which are connected to each other by the inner lead are sealed into a filler, and
an edge along the longitudinal direction of the bus bar electrode and a portion from the edge to a predetermined distance inward therefrom are brought into direct contact with the filler.

2. The solar cell module according to claim 1, wherein the bus bar electrode is joined to the inner lead with a solder at its center in the transverse direction.

3. The solar cell module according to claim 1, wherein the width of the inner lead is smaller than the width of the bus bar electrode.

4. The solar cell module according to claim 1, wherein the solar cell element has a plurality of finger electrodes at least one ends of which are connected to the bus bar electrode formed on its light receiving surface and/or non-light receiving surface.

5. The solar cell module according to claim 4, wherein the finger electrode is brought into direct contact with the filler over its whole length.

6. The solar cell module according to claim 4, wherein the one end, connected to the bus bar electrode, of the finger electrode is coated with a coating member.

7. The solar cell module according to claim 6, wherein the coating member in the finger electrode is a solder resist.

8. The solar cell module according to claim 1, wherein a solder for joining the bus bar electrode and the inner lead contains Bi.

9. The solar cell module according to claim 1, wherein a solder for joining the bus bar electrode and the inner lead contains Sn, and satisfies the following equation:
Σ(ViWi)<2.8(%)
(where i denotes the number of elements composing the solder, Vi denotes the contraction coefficient (%) at the time of solidification of each of the elements composing the solder, Wi denotes the percentage by weight of each of the elements composing the solder (the whole is taken as 1), and the sum Σ takes 1 to i)

10. A solar cell module comprising a plurality of solar cell elements in a flat plate shape, and an inner lead for electrically connecting a bus bar electrode provided on a light receiving surface of one of the solar cell elements and a bus bar electrode provided on a non-light receiving surface of the other solar cell element adjacent thereto, wherein
the solar cell elements which are connected to each other by the inner lead are sealed into a filler,
an edge along the longitudinal direction of the bus bar electrode and a portion from the edge to a predetermined distance inward therefrom are coated with a coating member, and
the coating member is brought into direct contact with the filler.

11. The solar cell module according to claim 10, wherein the coating member in the bus bar electrode is a solder resist.

12. The solar cell module according to claim 10, wherein the bus bar electrode is joined to the inner lead with a solder at its center in the transverse direction.

13. The solar cell module according to claim 10, wherein the solar cell element has a plurality of finger electrodes at least one ends of which are connected to the bus bar electrode formed on its light receiving surface and/or non-light receiving surface.

14. The solar cell module according to claim 13, wherein the one end, connected to the bus bar electrode, of the finger electrode is coated with the coating member.

15. The solar cell module according to claim 14, wherein the coating member in the finger electrode also serves as a coating member in the bus bar electrode.

16. The solar cell module according to claim 14, wherein the coating member in the finger electrode is a solder resist.

17. The solar cell module according to claim 10, wherein a solder for joining the bus bar electrode and the inner lead contains Bi.

18. The solar cell module according to claim 10, wherein a solder for joining the bus bar electrode and the inner lead contains Sn, and satisfies the following equation:
Σ(ViWi)<2.8(%)
(where i denotes the number of elements composing the solder, Vi denotes the contraction coefficient (%) at the time of solidification of each of the elements composing the solder, Wi denotes the percentage by weight of each of the elements composing the solder (the whole is taken as 1), and the sum Σ takes 1 to i)

19. A solar cell module comprising a plurality of solar cell elements in a flat plate shape, and an inner lead for electrically connecting a bus bar electrode provided on a light receiving surface of one of the solar cell elements and a bus bar electrode provided on a non-light receiving surface of the other solar cell element adjacent thereto, wherein
the inner lead and the bus bar electrode are electrically connected to each other with a solder, and
the solder contains Sn, and satisfies the following equation:
Σ(ViWi)<2.8(%)
(where i denotes the number of elements composing the solder, Vi denotes the contraction coefficient (%) at the time of solidification of each of the elements composing the solder, Wi denotes the percentage by weight of each of the elements composing the solder (the whole is taken as 1), and the sum Σ takes 1 to i)

20. The solder cell module according to claim 19, wherein the solder contains Bi.

21. The solder cell module according to claim 20, wherein the solder contains 3 to 85% by weight of Bi.

22. The solar cell module according to claim 19, wherein the bus bar electrode is mainly composed of Ag, and the solder contains 0.5 to 6.5% by weight of Ag.

23. A solar cell module comprising:
a plurality of solar cell elements in a flat plate shape;
an inner lead for electrically connecting a bus bar electrode provided on a light receiving surface of one of the solar cell elements and a bus bar electrode provided on a non-light receiving surface of the other solar cell element adjacent thereto;
an outer lead connected to ends of the plurality of solar cell elements which are connected to one another by the inner lead; and
a coupling wiring for connecting the outer leads,
the outer lead and the coupling wiring being electrically connected to each other with a solder mainly composed of tin, silver, and copper, and
the bus bar electrode and the inner lead being electrically connected to each other with a solder mainly composed of tin, bismuth, and silver.

24. The solar cell module according to claim 23, wherein the bus bar electrode and the outer lead are electrically connected to each other with a solder mainly composed of tin, bismuth, and silver.

25. The solar cell module according to claim 23, wherein the composition of the solder mainly composed of tin, silver, and copper is 1.0 to 5.0% by weight of silver, 0.4 to 7.0% by weight of copper, and the remaining percent by weight of tin.

26. The solar cell module according to claim 23, wherein the composition of the solder mainly composed of tin, bismuth, and silver is 20 to 60% by weight of bismuth, 0.5 to 5% by weight of silver, and the remaining percent by weight of tin.
